(19) United States
(12) Patent Application Publication
(10) Pub. No.: US 2025/0242246 A1
(43) Pub. Date: Jul. 31, 2025

(54) VIDEO GAME CONTROLLER OVERLAY TO VISUALLY INDICATE VIDEO GAME PLAYER'S PHYSICAL CONTROLS

(71) Applicant: Sony Interactive Entertainment Inc., Tokyo (JP)

(72) Inventors: Peter Mattias Alexander Erlo, San Francisco, CA (US); Andrew E. Tompkins, Surfside Beach, TX (US); Momoko Tsuchiya, Kanagawa (JP)

(21) Appl. No.: 18/427,646

(22) Filed: Jan. 30, 2024

(51) Int. Cl. A63F 13/533

(52) U.S. Cl. CPC A63F 13/533

(57) ABSTRACT

Systems and methods described herein include displaying, on a display, a virtual gaming controller that is a graphical representation of a physical gaming controller being operated by a user. In response to the user interacting with a control input on the physical gaming controller, the control input entered by the user on the physical gaming controller is detected, after which a graphical indicator is displayed on the display, the graphical indicator including an animated image and overlaying a control input on the virtual gaming controller that corresponds to the control input entered by the user on the physical gaming controller. The animated image is generated on the display in a first size in response to detecting that the user engaged the control input of the physical gaming controller, and in a second, smaller, size in response to detecting that the user released the control input of the physical gaming controller.

### TECHNICAL FIELD

This invention relates generally to video game interfaces and, more specifically, to video game interface that visually indicate a user's interaction with a physical gaming controller.

### BACKGROUND

It has become common in recent years for video game players to stream their game play to other players online. Such online streaming may be used for purposes of video game walkthroughs, online video game tournaments, video game developing, and the like. While the spectators watching the streaming video game play can see the in-game movements of the characters/objects on a display screen, they cannot see the streamer's interactions with the video game controller that cause the in-game movements of the characters/objects observed by the spectators. Since the spectators are unable to see the streamer's actual interaction with the inputs of the streamer's physical video game controller, the spectators are likely to experience significant difficulty when attempting to imitate the streamer's game play within their own video games.

### SUMMARY

In some embodiments, a method includes: displaying a virtual gaming controller on a display, wherein the virtual gaming controller is a graphical representation of a physical gaming controller being operated by a user; detecting, in response to the user interacting with a control input on the physical gaming controller, the control input entered by the user on the physical gaming controller; generating, on the display, a graphical indicator comprising an animated image and overlaying a control input on the virtual gaming controller that corresponds to the control input entered by the user on the physical gaming controller; generating the animated image on the display in a first size in response to detecting that the user has engaged the control input of the physical gaming controller; and generating the animated image on the display in at least one second, smaller, size in response to detecting that the user has released the control input of the physical gaming controller.

In some aspects, the method further includes displaying a gaming graphical user interface on the display and displaying the virtual gaming controller as an overlay over a portion of the graphical user interface. In one implementation, the virtual gaming controller is at least partially transparent to permit the portion of the graphical user interface underlaying the virtual gaming controller to be visible on the display through the virtual gaming controller.

In certain embodiments, the method includes detecting a pressure exerted by the user onto the control input of the physical gaming controller, with the magnitude of the first size of the animated image generated on the display being proportional to a magnitude of the pressure detected on the control input of the physical gaming controller.

In some implementations, the graphical indicator includes a first animated image overlaying a first analog control input of the virtual gaming controller and a second animated image overlaying a second analog control input of the virtual gaming controller. The method may further include detecting directional movements of the first analog control input of the physical gaming controller and causing the first animated image overlaying the first analog control input of the virtual gaming controller to perform corresponding directional movements and offset on the display from the first analog control input of the virtual gaming controller; and detecting directional movements of the second analog control input of the physical gaming controller and causing the second animated image overlaying the first analog control input of the virtual gaming controller to perform corresponding directional movements and offset on the display from the second analog input of the virtual gaming controller.

In certain aspects, prior to the displaying the virtual gaming controller on the display, the method may include detecting a type of the physical gaming controller being operated by the user and displaying, on the display, a type of virtual gaming controller that corresponds to the detected type of the physical gaming controller being operated by the user.

In some embodiments, a non-transitory computer readable storage medium storing one or more computer programs is configured to cause a processor-based system to execute steps including: displaying a virtual gaming controller on a display, wherein the virtual gaming controller is a graphical representation of a physical gaming controller being operated by a user; detecting, in response to the user interacting with a control input on the physical gaming controller, the control input entered by the user on the physical gaming controller; generating, on the display, a graphical indicator comprising an animated image and overlaying a control input on the virtual gaming controller that corresponds to the control input entered by the user on the physical gaming controller; generating the animated image on the display in a first size in response to detecting that the user has engaged the control input of the physical gaming controller; and generating the animated image on the display in at least one second, smaller, size in response to detecting that the user has released the control input of the physical gaming controller.

In some embodiments, a system comprises a display, a physical gaming controller, and a processor-based system in communication with the display and the physical gaming controller. The processor-based system is configured to execute steps that include: displaying a virtual gaming controller on a display, wherein the virtual gaming controller is a graphical representation of the physical gaming controller; detecting, in response to a user interacting with a control input on the physical gaming controller, the control input entered by the user on the physical gaming controller; generating, on the display, a graphical indicator comprising an animated image and overlaying a control input on the virtual gaming controller that corresponds to the control input entered by the user on the physical gaming controller; generating the animated image on the display in a first size in response to detecting that the user has engaged the control input of the physical gaming controller; and generating the animated image on the display in at least one second, smaller, size in response to detecting that the user has released the control input of the physical gaming controller.

In some embodiments, a method includes processing video data that, when played, displays a virtual gaming controller along with one or more animated images corresponding to one or more control inputs on the virtual gaming controller, wherein as the video data is played, each of the animated images provides a visual indication of manipulations of its respective control input; based on the visual indications provided by the one or more animated images, generating a sequence of the manipulations of the one or more control inputs; and using the sequence in a processor-based system to generate and display information on a display.

In certain aspects, the method further includes using the sequence as input to a quality control application. In some implementations, the video data when played further displays a computer simulation that was controlled by a physical gaming controller that is represented by the virtual gaming controller. In some embodiments, the method further includes generating the sequence so that the manipulations of the one or more control inputs in the sequence are substantially synchronized with corresponding manipulations of the one or more control inputs in the video data.

A better understanding of the features and advantages of various embodiments of will be obtained by reference to the following detailed description and accompanying drawings which set forth illustrative embodiments of the invention.

### BRIEF DESCRIPTION OF THE DRAWINGS

Disclosed herein are embodiments of systems and methods pertaining to on-screen split virtual keyboards that enable the user to enter characters using two separate cursors. This description includes drawings, wherein:

FIG. 1 depicts a display screen view diagram illustrating a user interface in according with some embodiments;

FIG. 2 depicts a display screen view diagram showing a hand-held controller and a virtual controller shown as an overlay in a user interface in accordance with some embodiments;

FIG. 3 depicts a display screen view diagram showing a hand-held controller and a virtual controller shown as an overlay in a user interface in accordance with some embodiments;

FIG. 4 depicts a display screen view diagram showing a hand-held controller and a virtual controller shown as an overlay in a user interface in accordance with some embodiments;

FIG. 5 depicts a display screen view diagram showing a hand-held controller and a virtual controller shown as an overlay in a user interface in accordance with some embodiments;

FIG. 6 depicts a display screen view diagram showing a hand-held controller and a virtual controller shown as an overlay in a user interface in accordance with some embodiments;

FIG. 7 depicts a display screen view diagram showing a hand-held controller and a virtual controller shown as an overlay in a user interface in accordance with some embodiments;

FIG. 8 depicts a display screen view diagram showing a virtual controller corresponding to a VR controller and shown as an overlay in the user interface in accordance with some embodiments;

FIG. 9 depicts a display screen view diagram showing a virtual controller corresponding to a VR controller and shown as an overlay in the user interface in accordance with some embodiments;

FIG. 10 depicts a display screen view diagram showing a virtual controller corresponding to a VR controller and shown as an overlay in the user interface in accordance with some embodiments;

FIG. 11 is a schematic diagram of a system in accordance with some embodiments;

FIG. 12 is a block diagram of a computing device in accordance with some embodiments;

FIG. 13 is a flow diagram representative of a method in accordance with some embodiments; and

FIG. 14 is a flow diagram representative of a method in accordance with some embodiments.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems and methods described herein include displaying, on a display, a virtual gaming controller that is a graphical representation of a physical gaming controller being operated by a user. A control input entered by the user while interacting with the physical gaming controller is detected, after which a graphical indicator is displayed on the display. This graphical indicator includes an animated image that overlays a control input on the virtual gaming controller that corresponds to the control input entered by the user on the physical gaming controller. The animated image is generated on the display in a first size in response to detecting that the user engaged the control input of the physical gaming controller, and in a second, smaller, size in response to detecting that the user released the control input of the physical gaming controller.

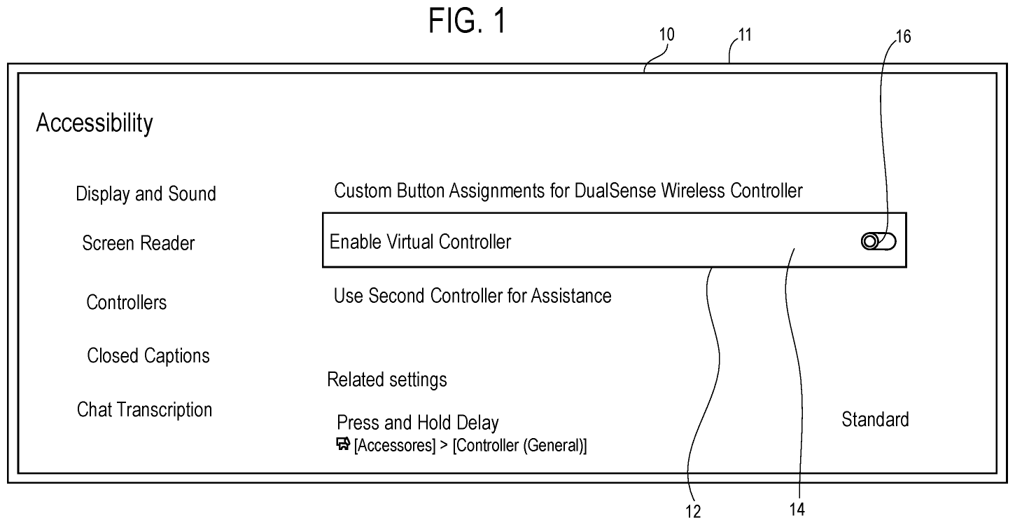

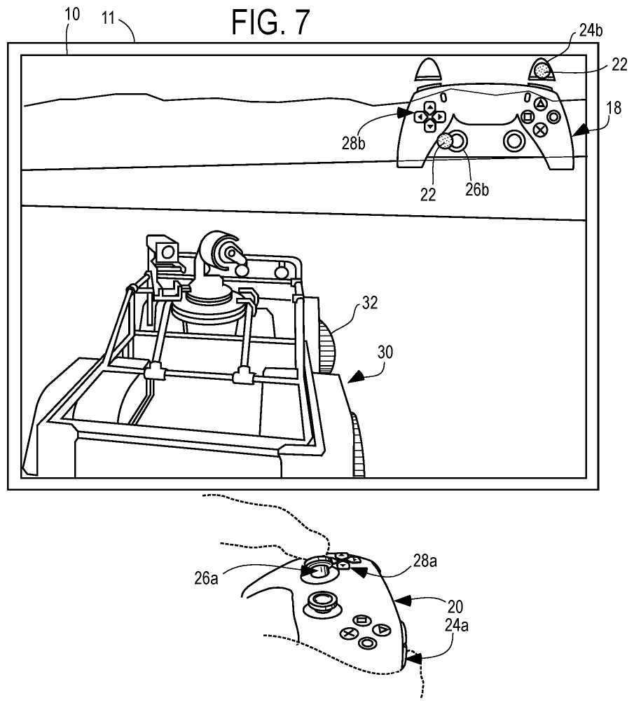

FIG. 1 shows a user interface 10, which may be displayed on a screen 11 of a display (e.g., a television, monitor, handheld device, etc.), and which enables a user to select various video game-related options. The exemplary user interface 10 is in a form of a menu, which includes a cursor 12 movable by the user's interactions with a physical gaming controller 20 between various fields 14 associated with various video game-related options and selectable by the user's interactions with the physical gaming controller 20. It will be appreciated that the user interface 10 is not limited to menu option-type displays and may, in some embodiments, be in the form of a video game developer application, a quality control application, or an in-game display as shown, for example, in FIG. 7.

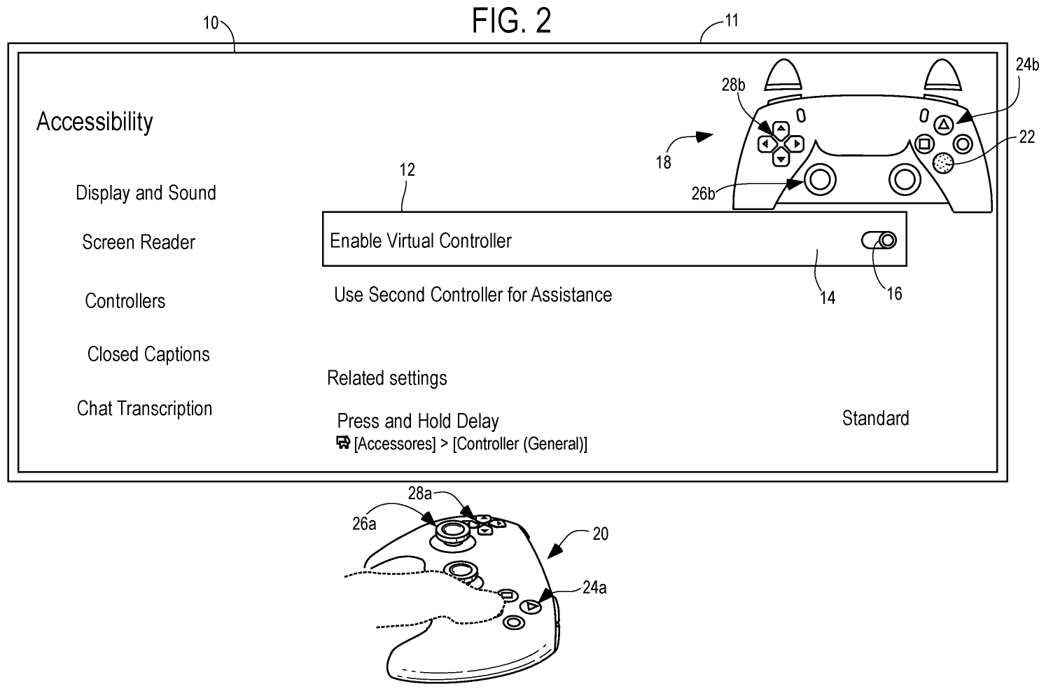

One of the user-selectable fields 14 included in the exemplary user interface 10 of FIG. 1 relates to the enabling of a virtual gaming controller, which will be discussed in more detail below. In the illustrated embodiment, the “Enable Virtual Controller” option 14 includes a button 16, which is slidable between the OFF position (shown in FIG. 1) and the ON position (shown in FIG. 2). To enable the virtual gaming controller option within the exemplary user interface 10 of FIG. 1, a user would move the cursor 12 via a directional pad, an analog stick, or the like of the user's physical gaming controller 20 to position the cursor 12 over the “Enable Virtual Controller” option 14, after which the user would press a button (or a touch pad, analog stick, etc.) on the user's physical gaming controller 20 to slide the button 16 from the OFF to the ON position.

FIG. 2 shows the user interface 10 after the slidable button 16 has been moved to the ON position by the user's interaction with the user's physical gaming controller 20, which enables the virtual gaming controller 18, and causes the user interface 10 to generate an image of the virtual gaming controller 18 as an overlay over a portion of the user interface 10. In the illustrated embodiment, the virtual gaming controller 18 is generated in the upper right-hand corner of the screen 11, but it will be appreciated that the virtual gaming controller 18 may be generated in any location of the user interface 10. In some embodiments, the virtual gaming controller 18 is at least partially or semi-transparent so as to not completely obstruct the portion of the user interface 10 that underlies the virtual gaming controller 18.

In some embodiments, after the user manipulates the physical gaming controller 20 to move the slidable button 16 to the ON position and enable the virtual gaming controller 18, a check is performed by the gaming console to determine a type of the physical gaming controller 20 being operated by the user (e.g., whether the user is utilizing a hand-held controller, a head-mounted virtual reality controller, etc.). In certain aspects, to detect the type of the physical gaming controller 20 being operated by the user may include the physical gaming controller 20 (upon start-up of the gaming console, in response to a query from the gaming console, etc.) sending a signal to the gaming console, which permits the gaming console to identify the type of the physical gaming controller 20 that is connected to the gaming console.

After the type of the physical gaming controller 20 being operated by the user is detected, the user interface generates on the display screen 11 a type of virtual gaming controller 18 that corresponds to the detected type of the physical gaming controller 20 being operated by the user. For example, in the example provided in FIG. 2, the virtual gaming controller 18 generated within the user interface 10 is visually identical to the hand-held physical gaming controller 20 that was detected by the gaming console.

In some embodiments, after the virtual gaming controller 18 is enabled via the slidable button 16 of the menu option 14 within the user interface 10, each interaction by the user with a control input (analog stick, button, touch pad, etc.) of the physical gaming controller 20 is detected (e.g., by the physical gaming controller 20, gaming console, and/or another device, etc.). In some aspects, as will be discussed below, each interaction of the user with a control input of the physical gaming controller 20 as the user controls an on-screen menu or an on-screen video game is detected (and may be recorded and stored in an electronic database for future retrieval) and causes the user interface 10 to generate a visual indicator 22 overlaying the corresponding control input on the virtual gaming controller 18 displayed within the user interface 10.

For example, in the illustrated embodiment, after each interaction of the user with a control input 24a, 26a of the physical gaming controller 20 (while the user controls an on-screen menu or an on-screen video game) is recorded, the user interface 10 is caused to generate a graphical indicator 22 that at least in part overlays a control input 24b, 26b on the virtual gaming controller 18 that corresponds to the control input 24a, 26a entered by the user on the physical gaming controller 20. In the embodiment illustrated in FIG. 2, in response to the user pressing the control input 24a (e.g., the “X” or “Cross” button) of the physical gaming controller 20 using a user's finger to cause the button 16 to slide from the OFF position to the ON position, the user interface 10 is caused to generate an exemplary graphical indicator 22 in the form of a circular animated image that overlays the control input 24b of the virtual gaming controller 18 that corresponds to the control input 24a of the physical gaming controller 20 that was pressed by the user. While the graphical indicator 22 is shown in FIG. 2 in the form of a circle fully overlaying the “Cross” button of the virtual gaming controller 18, it will be appreciated that the graphical indicator 22 may be of any other shape and may overlay only a part of the control input 24a that was interacted with (e.g., pressed) by the user on the physical gaming controller 20.

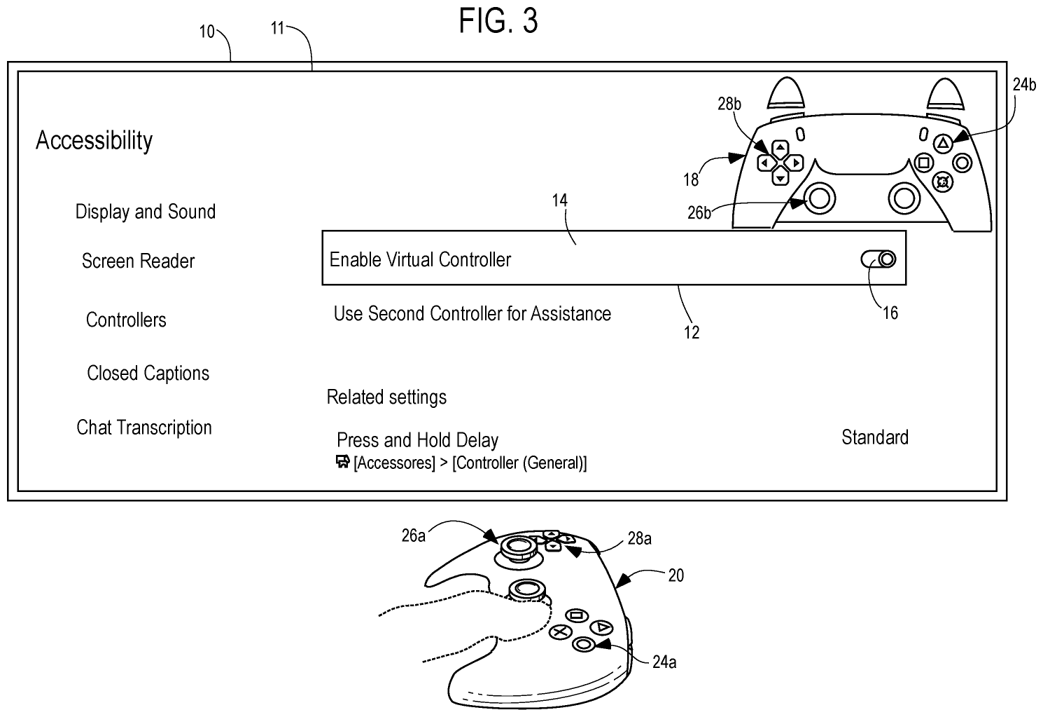

In the exemplary embodiment illustrated in FIGS. 2-3, the user interface 10 may be configured to generate the animated image of the graphical indicator 22 on the display 11 in a first size (e.g., a larger, full size as shown in FIG. 2) in response to detecting that the user has engaged (i.e., pressed or moved) the control input 24a (e.g., a button, analog stick, etc.) of the physical gaming controller 20. In some aspects, after the user releases (i.e., removes the user's finger) from the control input 24a of the physical gaming controller 20, the animated image of the graphical indicator 22 does not immediately disappear from view within the user interface 10.

Instead, the animated image of the graphical indicator 22 disappears from view with a trailing effect, and sequentially decreases in size from the full size shown in FIG. 2 to a series of smaller sizes (one exemplary smaller size shown in FIG. 3) over a predetermined interval (e.g., from about 0.5 seconds to about 1 second) until the graphical indicator 22 fully disappears from view within the user interface 10. This exemplary trailing effect of the graphical indicator 22 makes it easier for those viewing the screen 11 (e.g., spectators watching a stream of video game play) to see the user's interactions with the control inputs 24a of the physical gaming controller 20, which can be important when the user is playing a fast-paced video game, and the user's interactions with the control inputs 24a of the physical gaming controller 20 can happen quickly.

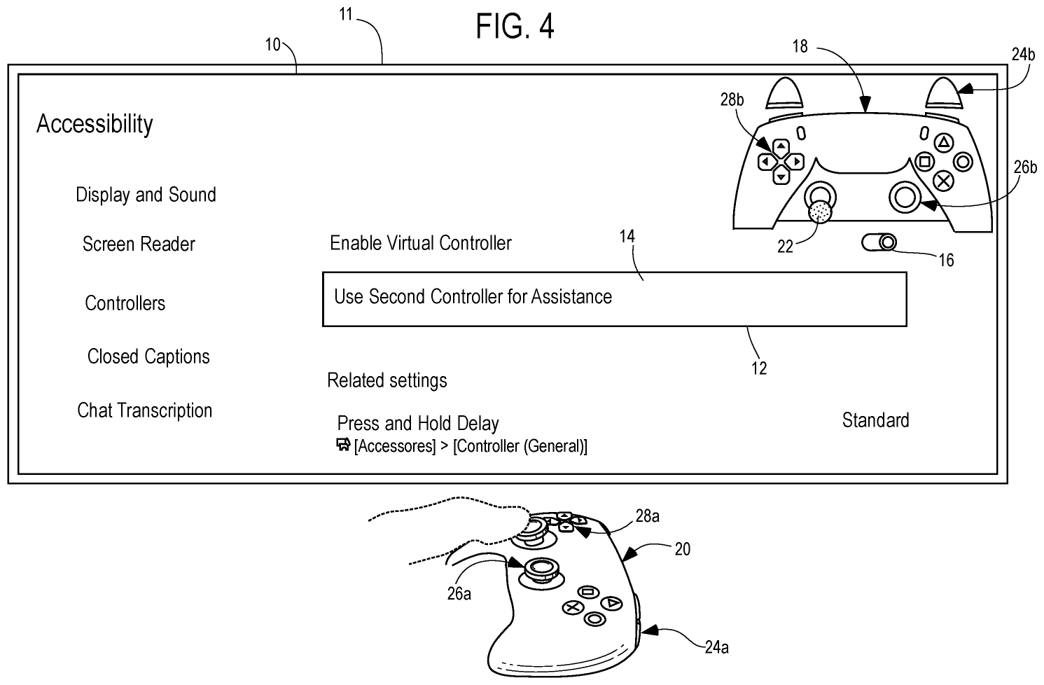

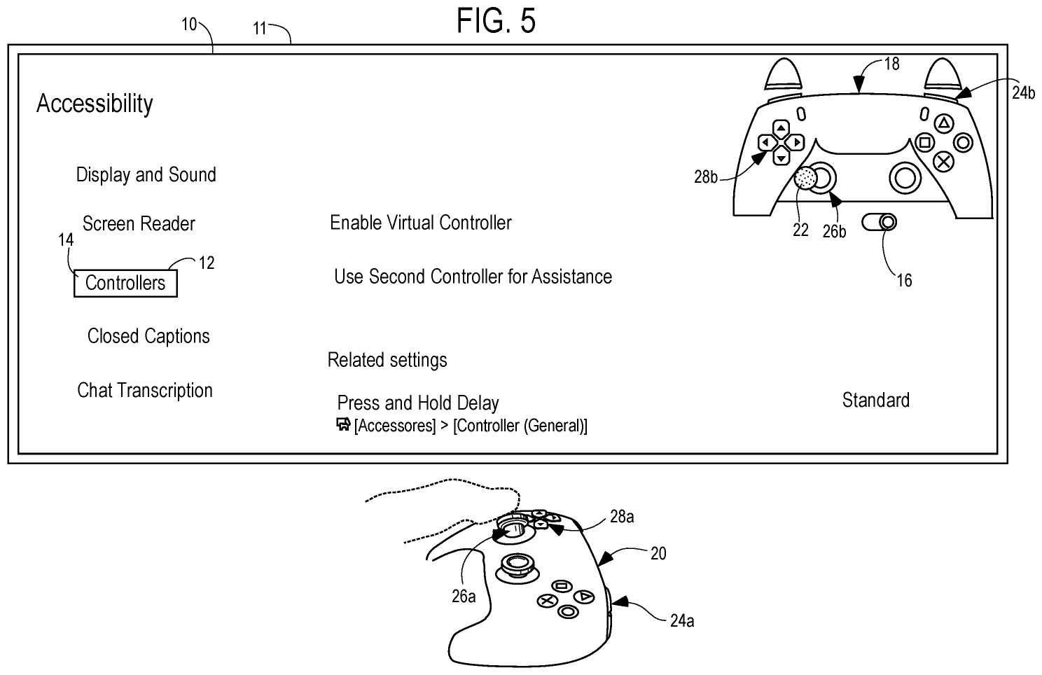

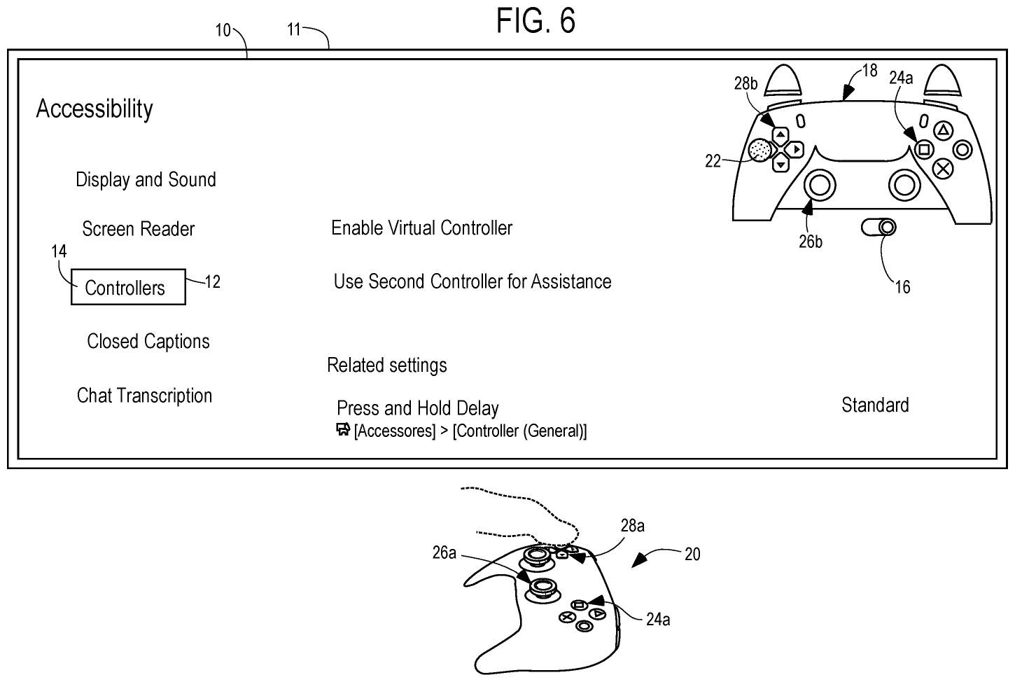

While FIGS. 2-3 illustrate the generation of a graphical indicator 22 within the user interface 10 in response to a user's interaction with a pressable button-based control input 24a of the physical gaming controller 20, FIGS. 4-5 illustrate the generation of a graphical indicator 22 within the user interface 10 in response to a user's interaction with a directionally movable analog stick-based control input 26a of the physical gaming controller 20, while FIG. 6 shows the generation of a graphical indicator 22 within the user interface 10 in response to a user's interaction with a pressable directional pad-based control input 28a of the physical gaming controller 20.

With reference to FIG. 4, a user may move the control input 26a (i.e., the left analog stick) of the physical gaming controller 20 to the left by using a user's finger and thereby moving the cursor 12 from the lower sub-branch menu option 14 (which allows the user to enable the virtual gaming controller 18) to a higher sub-branch menu option 15 (which allows the user to select menu options related to Controllers). In response, the user interface 10 may be caused to generate an exemplary graphical indicator 22 in the form of a circular animated image that visually indicates, on the virtual gaming controller 18, the direction (i.e., left) in which the left analog stick 26a was moved by the user on the physical gaming controller 20.

As can be seen in FIG. 4, the animated image representing the graphical indicator 22 is offset to the left relative to the left analog stick 26b of the virtual gaming controller 18 to visually indicate that the user moved the left analog stick 26a of the physical gaming controller 20 to the left relative to its initial position. Notably, in the embodiment illustrated in FIG. 4, the left analog stick 26a of the virtual gaming controller 18 does not move to the left, but the graphical indicator 22 being displayed as offset to the left from the left analog stick 26a of the virtual gaming controller 18 visually indicates that the user has moved the left analog stick 26a of the physical gaming controller 20 to the left.

Notably, while the exemplary user interface 10 of FIG. 4 shows that the graphical indicator 22 overlaying a portion of the left analog stick 26b of the virtual gaming controller 18, it will be appreciated that, in some embodiments, in response to the user's movement of the left analog stick 26a to the left on the physical gaming controller 20, the graphical indicator 22 may be shown within the user interface 10 as being completely offset to the left of (and not overlaying any part of) the left analog stick 26b of the virtual gaming controller 18. It should also be noted that while the graphical indicator 22 is shown in FIG. 4 in the form of a circle, it will be appreciated that the graphical indicator 22 may be of any other shape.

With reference to FIG. 5, in some aspects, the user may move the control input 26a (i.e., the left analog stick) of the physical gaming controller 20 down using a user's finger for the purpose of moving the cursor 12 from the lower sub-branch menu option 14 (which allows the user to enable the virtual gaming controller 18) to the exemplary lower sub-branch menu option 15 that is located immediately below the menu option 14 (and which permits the user to enable the use of a second controller). In response, the user interface 10 is caused to generate an exemplary graphical indicator 22 in the form of a circular animated image that visually indicates, on the virtual gaming controller 18 the direction (i.e., down) in which the left analog stick 26a was moved by the user on the physical gaming controller 20. As can be seen in FIG. 5, the animated image representing the graphical indicator 22 is offset downwardly relative to the left analog stick 26b of the virtual gaming controller 18 to visually indicate that the user moved the left analog stick 26a of the physical gaming controller 20 down relative to its initial position.

Notably, while the exemplary user interface 10 of FIG. 5 shows that the graphical indicator 22 overlaying a portion of the left analog stick 26a of the virtual gaming controller 18, it will be appreciated that, in some embodiments, in response to the user's movement of the left analog stick 26a downwardly on the physical gaming controller 20, the graphical indicator 22 may be shown within the user interface 10 as being completely offset downwardly from (and not overlaying any part of) the left analog stick 26b of the virtual gaming controller 18. It should be noted that while the graphical indicator 22 is shown in FIG. 5 in the form of a circle, it will be appreciated that the graphical indicator 22 may be of any other shape.

With reference to FIG. 6, in some aspects, the user may press a left directional pad of the control input 28a of the physical gaming controller 20 using a user's finger for the purpose of moving the cursor 12 from the lower sub-branch menu option 14, or from the lower sub-branch menu option 15, to a higher sub-branch menu option 17 (which allows the user to select menu options related to Controllers). In response, the user interface 10 may be caused to generate a graphical indicator 22 in the form of a circular animated image that visually indicates on the virtual gaming controller 18 the specific (i.e., left) directional pad 28b corresponding to the left directional pad 28a that was pressed by the user on the physical gaming controller 20. As can be seen in FIG. 6, the animated image representing the graphical indicator 22 overlays a large portion (if not all) of the left directional pad 28b of the virtual gaming controller 18 to visually indicate that the user pressed the left directional pad of the control input 28a of the physical gaming controller 20.

Notably, while the exemplary user interface 10 of FIG. 6 shows that the graphical indicator 22 overlays a large portion (if not all) of the left directional pad of the control input 28b of the virtual gaming controller 18, it will be appreciated that, in some embodiments, in response to the user pressing the left directional pad 28a of the physical gaming controller 20, the graphical indicator 22 may be shown within the user interface 10 as overlaying only a portion (e.g., 75%, 50%, 25%, etc.) of the left directional pad 28b of the virtual gaming controller 18. It should also be noted that while the graphical indicator 22 is shown in FIG. 6 in the form of a circle, it will be appreciated that the graphical indicator 22 may be of any other shape.

Similarly to the exemplary user interface 10 discussed above with reference to FIGS. 2-3, the exemplary user interface 10 shown in each of FIGS. 4-6 may be configured to generate the animated image of the graphical indicator 22 on the display 11 in a first size (e.g., a larger, full size as shown in FIGS. 4-6) in response to detecting that the user has moved the left analog stick 26a of the physical gaming controller 20 to the left (see FIG. 4), or in response to detecting that the user has moved the left analog stick 26a of the physical gaming controller 20 down (see FIG. 5), or in response to detecting that the user pressed the left directional pad 28a of the physical gaming controller 20 (see FIG. 6).

As mentioned above, in some aspects, after the user releases the user's finger from the button-based control input 24a, or releases the user's finger or otherwise returns the analog stick-based control input 26a to its initial position, or releases the user's finger from the directional pad-based control input 28a of the physical gaming controller 20, the animated image of the graphical indicator 22 does not immediately disappear from view within the user interface 10. Instead, the graphical indicator 22 disappears from view with a trailing effect, sequentially decreasing in size from the full size shown in FIGS. 4-6 to a series of smaller sizes over a predetermined interval (e.g., from about 0.5 seconds to about 1 second) until the graphical indicator 22 disappears and is no longer visible within the user interface 10. This exemplary trailing effect of the graphical indicator 22 makes it easier for those viewing the screen 11 to see the user's interactions with the control inputs 24a, 26a, 28a of the physical gaming controller 20, which can be important when the user is playing a fast-paced video game and the user's interactions with the control inputs 24a, 26a, 28a of the physical gaming controller 20 happen fast.

While FIGS. 2-6 illustrate the generation of a graphical indicator 22 within the user interface 10 in response to a user's interaction with a pressable button-based control input 24a, a movable analog stick-based control input 26a, and a pressable directional pad-based control input 28a of the physical gaming controller 20 during menu option selection, FIG. 7 illustrates the generation of one or more graphical indicators 22 within the user interface 10 in response to a user's interaction with one or more control inputs 24a, 26a, 28a of the physical gaming controller 20 during video game play.

FIG. 7 shows an exemplary video game play, where the user controls movements of a vehicle 30 using the physical gaming controller 20 to control the speed of the vehicle 30 and control the direction of the front wheels 32 of the vehicle 30. As can be seen in FIG. 7, the virtual gaming controller 18 is semi-transparent such that it does not completely obstruct the portion of the user interface 10 and the objects/scenery of the video game that underly the virtual gaming controller 18. Notably, while FIGS. 2-6 show only one graphical indicator 22 being generated within the user interface 10, the user interface 10 is not limited to displaying only one graphical indicator 22 at a time. More specifically, depending on the number of the control inputs 24a, 26a, 28a being simultaneously interacted with by the user on the physical gaming controller 20, the user interface 10 is capable of displaying two graphical indicators 22 (as shown in FIG. 7), or three or more graphical indicators 22 as an overlay over the virtual gaming controller 18 at a time.

FIG. 7 shows a screen shot of an in-game sequence, where the user is interacting with the physical gaming controller 20 to cause the vehicle 30 to go forward and to the left. To that end, the user may simultaneously press a button-based control input 24a (e.g., the R2 button, located on the right-hand side of the top of the physical gaming controller 20 below the R1 button) and the analog stick-based control input 26a located on the left-hand side of the physical gaming controller 20. In response to detecting the user's interactions with the control inputs 24a and 26a on the physical gaming controller 20, the user interface 10 is caused to generate a first graphical indicator 22 in the form of a circular animated image over the button-based control input 24b corresponding to the button-based control input 24a of the physical gaming controller 20 interacted with by the user, as well as a second graphical indicator 22 in the form of a circular animated image over the analog stick-based control input 26b of the virtual gaming controller 18 that corresponds to the analog stick-based control input 26a interacted with by the user on the physical gaming controller 20. While the two exemplary graphical indicators 22 are shown in FIG. 7 as having an identical size and shape, it will be appreciated that, in some embodiments, each distinct graphical indicator 22 may have a differing shape and/or size.

In FIG. 7, the presence of the graphical indicators 22 overlaying the button-based control input 24b and the analog stick-based control input 26b of the virtual gaming controller 18, respectively, visually indicates the direction (i.e., left) in which the left analog stick 26a is being moved by the user while simultaneously pressing the top-right-hand-side R2 button 24a on the physical gaming controller 20. As can be seen in FIG. 7, the animated image representing the first graphical indicator 22 overlays a portion of the R2 button 24a (but may overlay the R2 button 24 in its entirety) to indicate that the user is actively pressing the R2 button 24a, while the second animated image representing the graphical indicator 22 is offset to the left relative to the left analog stick 26a of the virtual gaming controller 18 to visually depict that the user is actively moving the left analog stick 26a of the physical gaming controller 20 to the left relative to its initial position.

Notably, as pointed out above, the user interface 10 is not limited to simultaneously displaying only two graphical indicators 22 at a time. As such, if the user were to simultaneously move the right analog stick 26a (e.g., to change the camera angle) and/or press the X button 24a (e.g., to launch an object from the vehicle 30) of the physical gaming controller 20, the user interface 10 would be caused to additionally display a third graphical indicator 22 in association with (e.g., as an at least partial overlay) the right analog stick 26a of the physical gaming controller 20 and/or a fourth graphical indicator 22 in association with (e.g., as an at least partial overlay) the X button 24a of the physical gaming controller 20.

As pointed out above, in some embodiments, after the virtual gaming controller 18 is enabled via the slidable button 16 of the menu option 14 within the user interface 10, each interaction by the user with one or more control inputs (e.g., button 24a, analog joystick 26a, touch pad 28a, etc.) of the physical gaming controller 20 is detected (e.g., by the physical gaming controller 20, gaming console, another device, etc.), and one or more visible graphical indicator 22 are generated within the user interface 10 to graphically represent, on the virtual gaming controller 18, the physical interaction of the finger(s) of the user with the physical gaming controller 20. In certain implementations, in addition to detecting whether a button control input 24a of the physical controller 20 has been pressed or has been released and/or whether an analog stick 26a of the physical controller 20 has been moved up, down, left or right, a pressure exerted by the user onto a button-based control input 24a, an analog stick-based control input 26a, or a directional pad-based control input 28a of the physical gaming controller 20 may also be detected.

In some aspects, the size (e.g., diameter) of the graphical indicator 22 displayed within the user interface 10 is directly proportional to the magnitude of the force/pressure exerted by the fingers of the user onto a control input 24a, 26a, 28a of the physical gaming controller 20. For example, if, while controlling the vehicle 30 shown in FIG. 7, the user wanted the vehicle 30 to go forward at full speed and fully depressed the button-based control input 24a (i.e., moved the R2 button of the physical gaming controller 20 by 100% of its possible travel distance), while at the same time wanting to cause the wheels 32 of the vehicle 30 to turn only slightly to the left and moving the left analog stick 26a of the physical gaming controller 20 to the left by only 25% of its maximum possible travel distance to the left, the user interface 10 would generate a first graphical indicator 22 over the button-based control input 24b (e.g., R2 button) of the virtual gaming controller 18 that is of a maximum possible size of the graphical indicator 22, while also generating a second graphical indicator 22 that is offset to the left by 25% of its maximum possible offset to the left relative to the left analog stick 26b of the virtual gaming controller 18.

On the other hand, if, while controlling the vehicle 30 shown in FIG. 7, the user wanted the vehicle to go forward at half of the possible full speed and pressed the button-based control input 24a (e.g., R2 button) by only 50% of its possible travel distance while at the same time wanting to cause the vehicle 30 to make the sharpest possible turn to the left and moving the analog stick-based input 26a (e.g., left analog stick) by 100% of its maximum possible travel distance to the left, the user interface 10 would generate a first graphical indicator 22 over the button-based control input 24b of the virtual gaming controller 18 that is one half of the maximum possible size of the graphical indicator 22, while also generating a second graphical indicator 22 that is fully offset (i.e., by 100% of its possible travel distance) to the left relative to the left analog stick 26b of the virtual gaming controller 18.

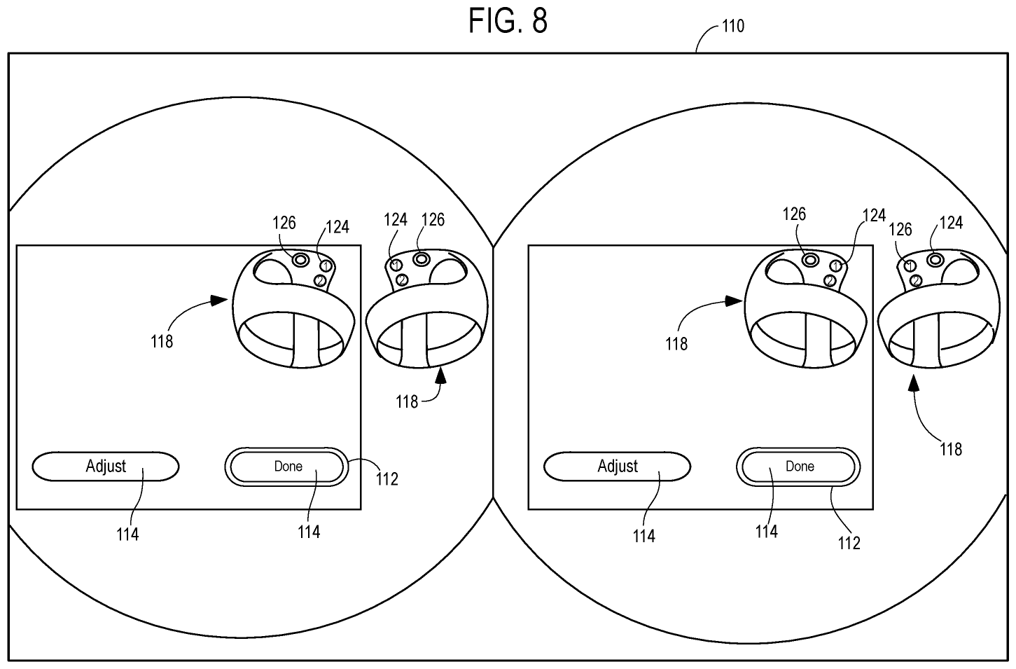

As discussed above, in some aspects, after the user manipulates the physical gaming controller 20 to move the slidable button 16 to the ON position and enable the virtual gaming controller 18 within the user interface 10, a check is performed by the gaming console to determine a type of the physical gaming controller 20 that is being operated by the user. The above-discussed FIGS. 2-7 depict various screen shots of an exemplary user interface 10 after a hand-held physical gaming controller 20 was detected. FIGS. 8-10 depict exemplary screen shots of an embodiment of a user interface 110 after an exemplary virtual reality (VR) controller having a head-mounted component and a hand-held component was detected.

FIG. 8 shows a user interface 110, which may be displayed on a screen 111 of a display (e.g., a television, monitor, handheld device, etc.) after the presence of a VR controller is detected, and which may enable a user to make various selections relating to the calibration of the components of the VR controller, or to make various selections relating to the game console or video game options, or to use the hand-held component of the VR controller to control various in-game actions, movements, and the like. The exemplary user interface 110 shown in FIG. 8 is in a form of a menu, which includes a cursor 112 movable by the user's interactions with the hand-held component of the VR controller (not shown) between various fields 114 associated with various user-selectable controller and/or video game-related options. It will be appreciated that the user interface 110 is not limited to menu option-type displays as shown in FIGS. 8-10 and may, in some embodiments, be in the form of an in-game display.

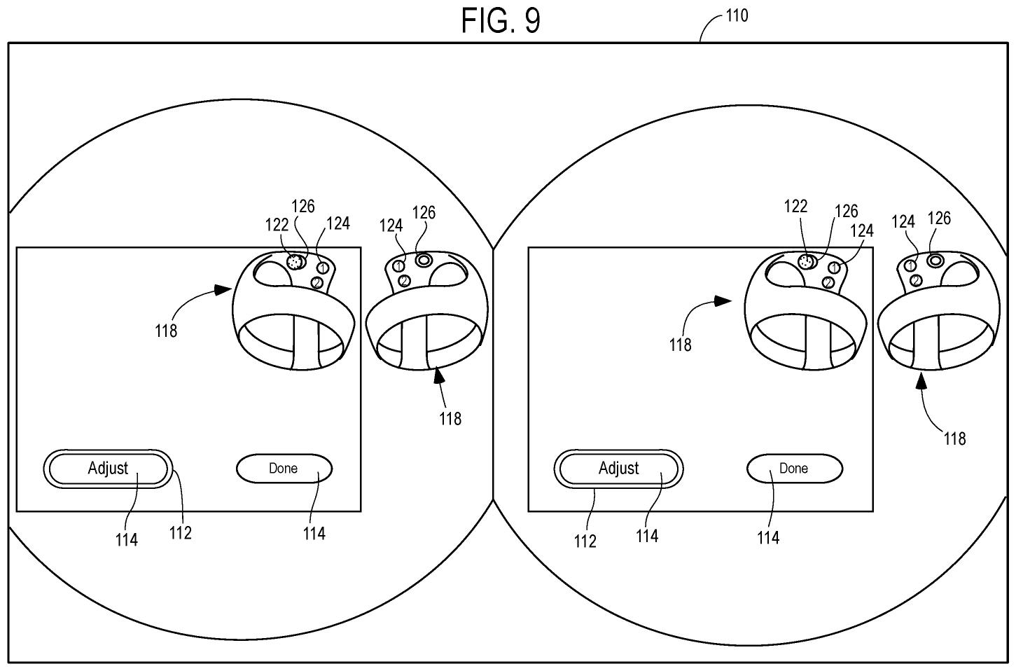

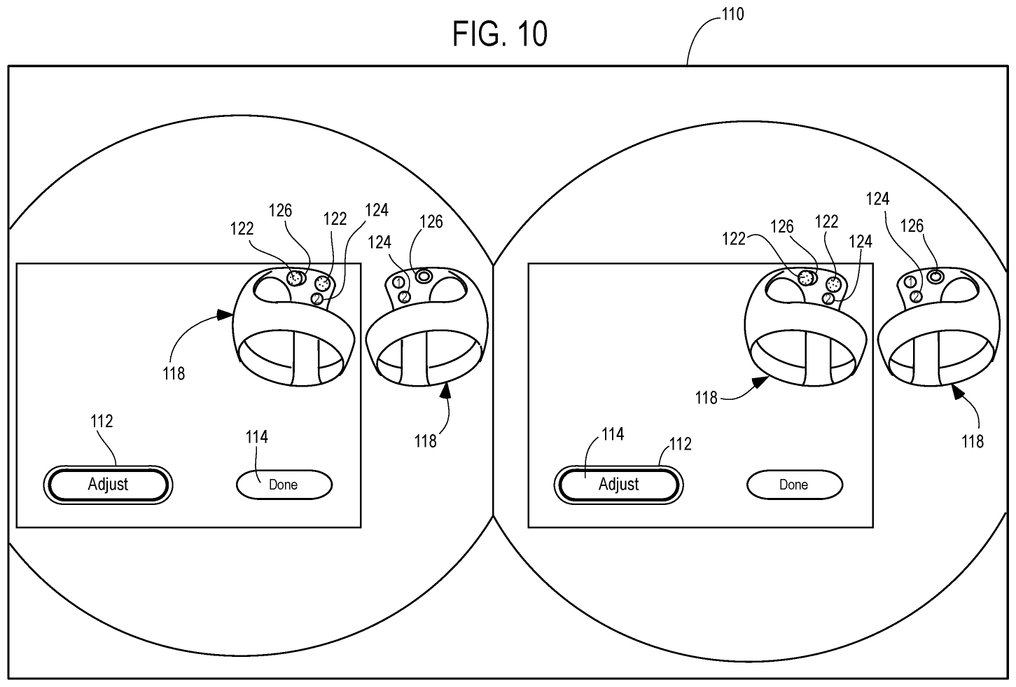

The exemplary user interface 110 in FIGS. 8-10 shows a menu with two user-selectable options 114, namely “Adjust” (which enables the user to select the height of the hand-held components of the VR controller relative to the floor) and “Done” (which finalizes the pre-sets made by the user after selecting the “Adjust” option). With reference to FIG. 9, if the user did not want to finalize the settings of the VR controller, but instead wanted to adjust some of the settings, instead of pressing a button-based control input on the hand-held component of the VR controller to select the “Done” option 114 to exit out of the VR settings menu, the user would use the user's fingers to move the analog stick-based control input on the hand-held component of the VR controller to the left, thereby moving the cursor 112 from being positioned around the “Done” option 114 to being positioned around the “Adjust” option 114, as shown in FIG. 10. After moving the cursor 112 over the user-desired “Adjust” option 114, the user would press a button-based control input on the hand-held component of the VR controller to select the “Adjust” option 114 as shown in FIG. 10, which would then open a sub-menu with various user-selectable setting selections underlying the option 114, as shown in FIG. 10.

In the illustrated embodiment, the exemplary virtual gaming controllers 118 are generated in the upper right-hand corner of each of the left and right VR menus within the user interface 110. However, it will be appreciated that the virtual gaming controllers 118a-118b may be generated in any location of the user interface 110. Similarly to the virtual gaming controller 18, the virtual gaming controllers 118 may be semi-transparent so as to not completely obstruct the portion of the user interface 110 that underlies the virtual gaming controllers 118.

In the embodiment illustrated in FIGS. 9 and 10, after each interaction of the user with the control inputs of the hand-held component of the VR controller while the user controls an on-screen menu within the user interface 10, or while an on-screen video game is played, the user interface 110 is caused to generate a graphical indicator 122 that at least in part overlays one or more of the control inputs 124, 126 on the virtual gaming controllers 118 corresponding to one or more control inputs interacted with by the user on the hand-held component of the VR controller.

In the embodiment illustrated in FIG. 9, in response to the user using one or more fingers to move the analog stick control input of the hand-held component of the VR controller to the left, the user interface 110 is caused to generate an exemplary graphical indicator 122 in the form of a circular animated image that visually indicates, as an overlay on the virtual gaming controller 118, the direction (i.e., left) in which the analog stick control input was moved by the user on the hand-held component of the VR controller. As can be seen in FIG. 9, the animated image representing the graphical indicator 122 is offset to the left relative to the analog stick-based control input 126 of the virtual gaming controller 118 to indicate that the user moved the analog stick of the hand-held component of the VR controller to the left relative to its initial position.

Notably, while the exemplary user interface 110 of FIG. 9 shows that the graphical indicator 122 overlaying a portion of the left analog stick 126 of the virtual gaming controller 118, it will be appreciated that, in some embodiments, in response to the user's movement of the analog stick of the hand-held component of the VR controller to the left, the graphical indicator 122 may be shown within the user interface 110 as being completely offset to the left of (and not overlaying any part of) the analog stick-based control input 126. It should also be noted that while the graphical indicator 122 is shown in FIG. 9 in the form of a circle, it will be appreciated that the graphical indicator 122 may be of any other regular or irregular geometric shape.

In the embodiment illustrated in FIG. 10, in response to the user's finger pressing the button-based control input of the hand-held component of the VR controller, the user interface 110 is caused to generate an exemplary graphical indicator 122 in the form of a circular animated image that overlays the corresponding button-based control input 124 of the virtual gaming controller 124. While the graphical indicator 122 is shown in FIG. 10 in the form of a circle fully overlaying the button-based control input 124 of the virtual gaming controller 118, it will be appreciated that the graphical indicator 122 may be of any other regular or irregular geometric shape, and may overlay only a part of the button-based control input 124 corresponding to the control input that was pressed by the user on the hand-held component of the VR controller.

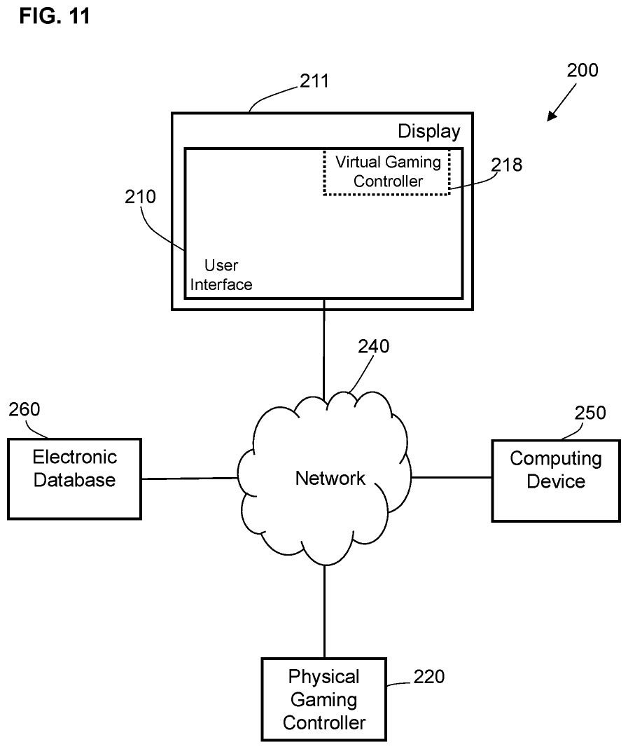

FIG. 11 shows an embodiment of a system 200 that enables a user to take advantage of various embodiments of the virtual gaming controllers 18, 118 described above. The exemplary system 200 shown in FIG. 11 includes a screen 211 (which may be the display of stand-alone device such as a television, monitor, etc., or which may be the display of a portable hand-held device, such as a portable gaming console, smart phone, tablet, laptop, etc.). The screen 211 may display a graphical user interface 210, which may be a video stream associated with a video game, an on-screen menu, or any other visual content which may be interacted with by a user using a controller. The system 200 of FIG. 11 includes a computing device 250 (which may be one or more computing devices on which video games may be played), which is coupled to a display screen 211 and configured to communicate, over a network (or connection) 240, with the display screen 211, one or more physical gaming controllers 220 (which may be wired or wireless and hand-held or head-mounted, etc.), and an electronic database 260 (which may be incorporated into the computing device 250 or stored on a computer/server remote to the computing device 250).

The exemplary network 240 depicted in FIG. 11 may be a wide-area network (WAN), a local area network (LAN), a personal area network (PAN), a wireless local area network (WLAN), Wi-Fi, Zigbee, Bluetooth (e.g., Bluetooth Low Energy (BLE) network), or any other internet or intranet network, or combinations of such networks. Generally, communication between various electronic devices of system 200 may take place over hard-wired, wireless, cellular, Wi-Fi or Bluetooth networked components or the like. In some embodiments, one or more electronic devices of system 200 may include cloud-based features or services, such as cloud-based memory storage, cloud-based predictive engine, etc.

The computing device 250 may be a stationary or portable electronic device, for example, a stationary gaming console, a portable gaming console, a desktop computer, a laptop computer, a tablet, a mobile phone, a single server or a series of communicatively connected servers, or any other electronic device including a control circuit that includes a programmable processor and may be coupled/connected to a display screen 211. In some embodiments, the computing device 250 is configured for running video games thereon (e.g., from a disc inserted into the computing device 250, from an onboard memory of the computing device 250, from a remote server/host, etc.) In some aspects, the computing device 250 is configured for data entry and processing and for communication with other devices of the system 200 via the network 240.

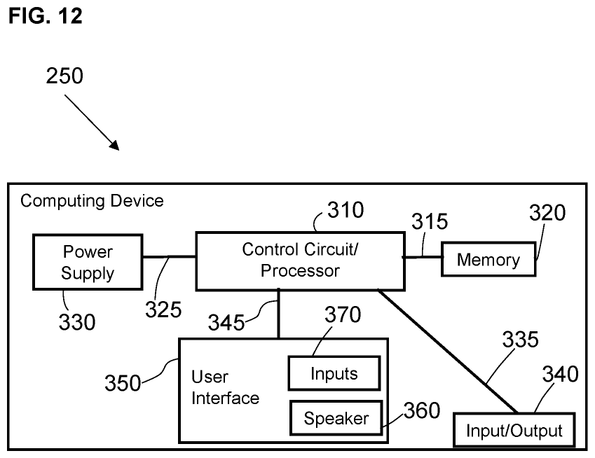

With reference to FIG. 12, an exemplary computing device 250 configured for use with exemplary systems and methods described herein includes a control circuit 310 including a programmable processor (e.g., a microprocessor or a microcontroller) electrically coupled via a connection 315 to a memory 320 and via a connection 325 to a power supply 330. The control circuit 310 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

The control circuit 310 can be configured (for example, by using corresponding programming stored in the memory 320 as will be well understood by those skilled in the art) to carry out one or more of the steps, actions, and/or functions described herein. In some embodiments, the memory 320 may be integral to the processor-based control circuit 310 or can be physically discrete (in whole or in part) from the control circuit 310 and is configured non-transitorily store the computer instructions that, when executed by the control circuit 310, cause the control circuit 310 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control unit may be referred to as a non-transitory medium or non-transitory computer readable medium.

The control circuit 310 of the computing device 250 is also electrically coupled via a connection 335 to an input/output 340 that can receive signals from, for example, from one or more physical gaming controllers 220 (which may be hand-held, head-mounted, etc.), electronic database 260, etc. The input/output 340 of the computing device 250 can also send signals to other devices, for example, the electronic display 211, the electronic database 260, physical gaming controllers 220, other stationary or portable computing devices, etc.

The processor-based control circuit 310 of the computing device 250 shown in FIG. 12 is electrically coupled via a connection 345 to a user interface 350, which may include inputs 370 (e.g., buttons, ports, touch screens, etc.) that permit an operator of the computing device 250 to manually control the computing device 250 by inputting commands via touch button operation and/or voice commands and/or via a physically connected device (e.g., physical gaming controller 220, etc.). Possible commands may, for example, cause the computing device 250 to turn on and off, reset, eject a video game disc, etc. In some embodiments, the user interface 350 of the computing device 250 may also include a speaker 360 that provides audible feedback (e.g., notifications, alerts, etc.) to the operator of the computing device 250. It will be appreciated that the performance of such functions by the processor-based control circuit 310 of the computing device 250 is not dependent on a human operator, and that the control circuit 310 of the computing device 250 may be programmed to perform such functions without a human operator.

With reference back to FIG. 11, the exemplary system 200 further includes one or more physical gaming controllers (which may be hand-held, head-mounted, etc.) 220. Generally, gaming-specific computing devices/entertainment systems such as stationary or portable gaming consoles (e.g., Sony PlayStation, PlayStation Portable, Microsoft X Box, Nintendo Switch, etc.) include a hand-held or a VR (e.g., head-mounted and/or hand-held) game controller, which permits a user to enter in-game or menu commands or other instructions into to the computing/gaming system to control a video game, a gaming-associated stream, or a gaming-associated menu.

The exemplary physical gaming controller 20 illustrated in FIG. 7 includes various control inputs. In the illustrated embodiment, the exemplary physical gaming controller 20 includes first (left) and second (right) analog sticks 26, which may be referred to herein collectively as “analog stick-based control inputs.” The physical gaming controller 20 also includes various buttons 24 that may be pushed by a user, and that may be referred to herein collectively as “button-based control inputs” In the embodiment shown in FIG. 7, the physical gaming controller 220 includes buttons 24 labeled, by way of example, with letters and/or symbols A, B, X, Y, “cross,” “circle,” “triangle,” “square,” L1, L2, R1, and/or R2, etc. Similarly, the exemplary virtual reality physical gaming controller (not shown) may include an analog stick, which may be referred to herein as an “analog stick-based control input.” The exemplary virtual reality physical gaming controller may also include buttons that may be pushed by a user, and that may be referred to herein collectively as “button-based control inputs.” In the exemplary embodiment shown in FIG. 9, each of the virtual gaming controllers 118 shown in FIG. 9 includes an analog stick and buttons labeled “1” and “2.”

In the embodiment illustrated in FIG. 11, the system 200 includes an electronic database 260. Generally, the exemplary electronic database 260 of FIG. 11 may be configured as a single database, or a collection of multiple communicatively connected databases and is configured to store data including but not limited to: data representing recordings of video game play resulting from manipulations (e.g., button presses, analog stick movements, etc.) of the physical gaming controller 220 by the user; data representing recordings of menu option selections resulting from manipulations (e.g., button presses, analog stick movements, etc.) of the physical gaming controller 220 by the user; and/or data representing sequences of manipulations (e.g., button presses, analog stick movements, etc.) of the physical gaming controller 220 by the user during game play, menu option selection, etc.

In some embodiments, the electronic database 260 and the computing device 250 may be implemented as two separate physical devices as shown in FIG. 11 and may be located at the same geographic location or different geographic locations relative to each other. It will be appreciated that the computing device 250 and the electronic database 260 may be implemented as a single physical device. In some aspects, the electronic database 260 may be stored, for example, on non-volatile storage media (e.g., a hard drive, flash drive, or removable optical disk) internal or external to the computing device 250, or internal or external to computing devices distinct from the computing device 250. In some aspects, the database 260 may be cloud-based.

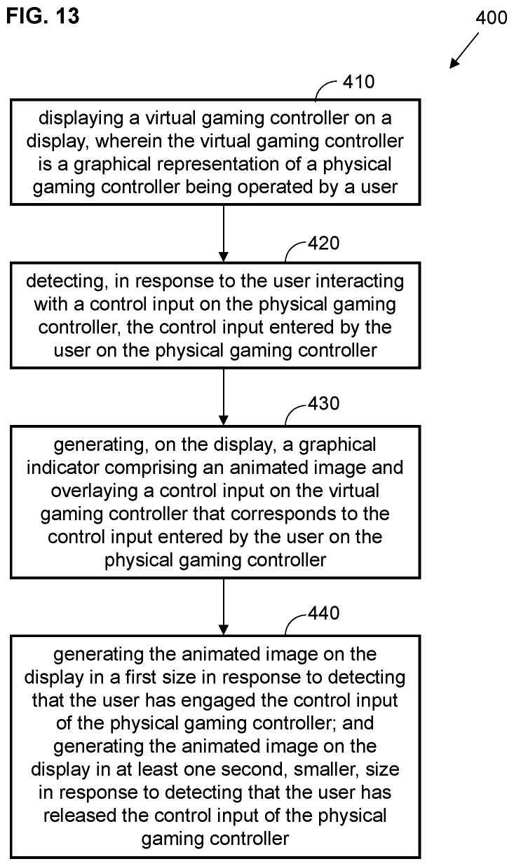

FIG. 13 shows an exemplary embodiment of a method 400 of providing a virtual gaming controller 18 within a user interface 10 on a screen 11 of a display. The method 400 includes displaying, on a display 11, a virtual gaming controller 18 that is a graphical representation of a physical gaming controller 20 being operated by a user (step 410). The physical gaming controller 20 may be a conventional hand-held gaming controller or a virtual reality head-mounted or hand-held controller.

As shown in FIG. 13, the method 400 includes detecting, in response to the user interacting with a control input 24a, 26a on the physical gaming controller 20, the control input 24a, 26a entered by the user on the physical gaming controller 20 (step 420). As mentioned above, in some embodiments, each interaction of the user with a button-based control input 24a or an analog stick-based control input 26a of the physical gaming controller (whether hand-held or head-mounted) may be detected by the computing device 250 (e.g., by the control circuit 310 thereof).

The illustrated exemplary method 400 further includes generating, on the display 11, a graphical indicator 22 comprising an animated image and overlaying a control input 24b, 26b on the virtual gaming controller 18 that corresponds to the control input 24a, 26a entered by the user on the physical gaming controller 20 (step 430). As discussed above, in some embodiments, after each interaction of the user with a control input 24a, 26a of the physical gaming controller 20 is detected while the user controls an on-screen menu or an on-screen video game, the user interface 10 is caused to generate a graphical indicator 22 that at least in part overlays a control input on the virtual gaming controller 18 that corresponds to the control input 24a, 26a entered by the user on the physical gaming controller 20.

For example, as discussed above, in some embodiments, after a type of the physical gaming controller 220 connected to the computing device 250 is detected (e.g., by the control circuit 310 of the computing device 250), the control circuit 310 of the computing device 250 causes the user interface 10 to generate a virtual gaming controller (e.g., virtual controller 18 in FIG. 2) of a type that matches the detected type of the physical gaming controller 220 being operated by the user. As also mentioned above, in some aspects, in response to the user pressing a button-based control input 24a (e.g., the “Xa” button) of the physical gaming controller 20 and/or in response to the user moving an analog stick-based control input 26a (e.g., the left analog stick) of the physical gaming controller 20, the control circuit 310 of the computing device 250 causes the user interface 10 to generate an exemplary graphical indicator 22 in the form of an animated image that overlays the control input(s) 24b, 26b of the virtual gaming controller 18 that correspond(s) to the button(s) that was pressed by the user on the physical gaming controller 20.

With reference to FIG. 13, the exemplary method 400 further includes generating the animated image 22 on the display 11 in a first size in response to detecting that the user has engaged the control input 24a, 26a of the physical gaming controller 20, and generating the animated image 22 on the display 11 in at least one second, smaller, size in response to detecting that the user has released the control input 24a, 26a of the physical gaming controller 20 (step 440). As discussed above, in some implementations, when the control circuit 310 of the computing device 250 detects that the user has engaged (i.e., pressed or moved) a control input 24a, 26a (e.g., a button, analog stick, etc.) of the physical gaming controller 20, the control circuit 310 of the computing device 250 causes the user interface 10 to generate the animated image of the graphical indicator 22 on the display 11 in a first size (e.g., a larger, full size as shown in FIG. 2).

On the other hand, after the user releases (i.e., removes the user's finger) from the control input 24a, 26a of the physical gaming controller 20, the control circuit 310 does not cause the animated image of the graphical indicator 22 to immediately disappear from view within the user interface 10. Instead, the control circuit 310 of the computing device 150 causes the animated image of the graphical indicator 22 to disappear from view with a trailing effect, sequentially decreasing in size from the full size shown in FIG. 2 to a series of smaller sizes (e.g., one exemplary smaller size is shown in FIG. 3) over a predetermined interval (e.g., from about 0.5 seconds to about 1 second) until the graphical indicator 22 fully disappears from view. This exemplary trailing effect of the graphical indicator 22 makes it easier for those viewing the screen 11 (e.g., spectators watching a streamer streaming the streamer's gameplay) to more clearly see each of the user's distinct interactions with the control inputs 24a, 26a of the physical gaming controller 20.

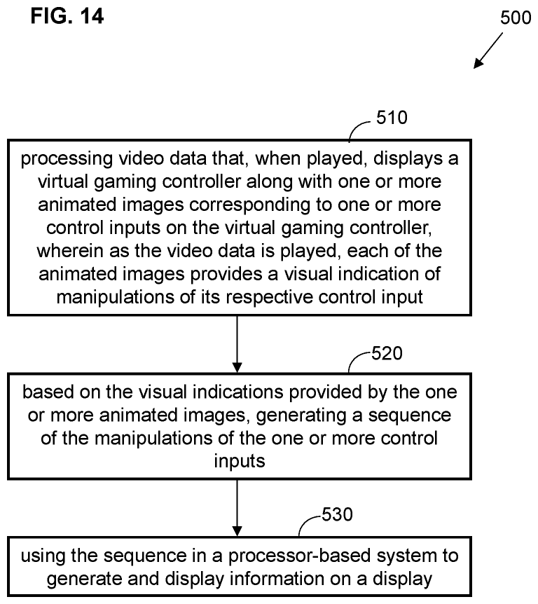

FIG. 14 illustrates an exemplary method 500 according to another embodiment. The method 500 includes processing video data that, when played, displays a virtual gaming controller 18 (e.g., on a screen 11 of a display) along with one or more animated images 22 corresponding to one or more control inputs (e.g., analog sticks and/or buttons) on the virtual gaming controller 18, such that when the video data is played, each of the animated images 22 provides a visual indication of the user's manipulations of its respective control input 24a, 26a on a physical gaming controller 20 being operated by the user (step 510).

In the illustrated embodiment, the method 500 further includes, generating, based on the visual indications provided by the one or more animated images 22, generating a sequence of the user's manipulations of the one or more control inputs 24a, 26a on the physical gaming controller 20 being operated by the user (step 520). Further, the method 500 includes using this sequence in a processor-based system (e.g., computing device 250 including the control circuit 310) to generate and display information on a screen 11 of a display (step 530).

Without wishing to be limited by theory, the method 500 may be useful not only for playing a video game or watching a video game played by someone else, but may also be useful for video game developing and/or quality control purposes. For example, the sequence of the user's manipulations of the one or more control inputs 24a, 26a on the physical gaming controller 20 (e.g., while playing a video game, making selections in a menu, etc.) may be used as an input to a quality control application, which may be operated via a computer, tablet, or mobile phone of one or more video game developers and used to evaluate and/or improve game play.

In certain embodiments, the sequence of the manipulations of the one or more control inputs 24a, 26a entered by the user on the physical gaming controller 20 is substantially synchronized with the sequence of the appearance and disappearance of the visual indicator 22 over the corresponding button-based control inputs 24b and/or analog stick control inputs 26b on the virtual gaming controller 18 depicted in the video data. In some aspects, the video data, when played, displays a computer simulation (e.g., a recording of the video game play or menu option selection) that was controlled by a physical gaming controller 20 represented by the on-screen virtual gaming controller 18, with this computer simulation simultaneously displaying both the game play or menu selection and the virtual gaming controller 18 with a sequential appearance and disappearance of the graphical indicator 22 to indicate each control input 24a, 26a that was interacted with by the user on the physical gaming controller 20.

Without wishing to be limited by theory, the ability of video game developers to see the button the user pressed on a physical gaming controller 20 and the responsive action of the on-screen menu or the on-screen video game advantageously allows video game developers to detect and fix any issues (failures, delays, bugs, glitches, etc.) in video games or on-screen menus.

In some embodiments, one or more of the embodiments, methods, approaches, schemes, and/or techniques described above may be implemented in one or more computer programs or software applications executable by a processor-based apparatus or system. By way of example, such processor-based system may comprise a smartphone, tablet computer, virtual reality (VR), augmented reality (AR), or mixed reality (MR) system, entertainment system, game console, mobile device, computer, workstation, gaming computer, desktop computer, notebook computer, server, graphics workstation, client, portable device, pad-like device, communications device or equipment, etc. Such computer program(s) or software may be used for executing various steps and/or features of the above-described methods, schemes, and/or techniques. That is, the computer program(s) or software may be adapted or configured to cause or configure a processor-based apparatus or system to execute and achieve the functions described herein. For example, such computer program(s) or software may be used for implementing any embodiment of the above-described methods, steps, techniques, schemes, or features. As another example, such computer program(s) or software may be used for implementing any type of tool or similar utility that uses any one or more of the above-described embodiments, methods, approaches, schemes, and/or techniques. In some embodiments, one or more such computer programs or software may comprise a VR, AR, or MR application, communications application, object positional tracking application, a tool, utility, application, computer simulation, computer game, video game, role-playing game (RPG), other computer simulation, or system software such as an operating system, BIOS, macro, or other utility. In some embodiments, program code macros, modules, loops, subroutines, calls, etc., within or without the computer program(s) may be used for executing various steps and/or features of the above-described methods, schemes and/or techniques. In some embodiments, such computer program(s) or software may be stored or embodied in a non-transitory computer readable storage or recording medium or media, such as a tangible computer readable storage or recording medium or media. In some embodiments, such computer program(s) or software may be stored or embodied in transitory computer readable storage or recording medium or media, such as in one or more transitory forms of signal transmission (for example, a propagating electrical or electromagnetic signal).

Therefore, in some embodiments the present invention provides a computer program product comprising a medium for embodying a computer program for input to a computer and a computer program embodied in the medium for causing the computer to perform or execute steps comprising any one or more of the steps involved in any one or more of the embodiments, methods, approaches, schemes, and/or techniques described herein. For example, in some embodiments the present invention provides one or more non-transitory computer readable storage mediums storing one or more computer programs adapted or configured to cause a processor-based apparatus or system to execute steps comprising any one or more of the embodiments, methods, approaches, schemes, and/or techniques described herein.

While the invention herein disclosed has been described by means of specific embodiments and applications thereof, numerous modifications and variations could be made thereto by those skilled in the art without departing from the scope of the invention set forth in the claims.

What is claimed is:

1. A method comprising:
displaying a virtual gaming controller on a display, wherein the virtual gaming controller is a graphical representation of a physical gaming controller being operated by a user;
detecting, in response to the user interacting with a control input on the physical gaming controller, the control input entered by the user on the physical gaming controller;
generating, on the display, a graphical indicator comprising an animated image and overlaying a control input on the virtual gaming controller that corresponds to the control input entered by the user on the physical gaming controller;
generating the animated image on the display in a first size in response to detecting that the user has engaged the control input of the physical gaming controller; and
generating the animated image on the display in at least one second, smaller, size in response to detecting that the user has released the control input of the physical gaming controller.

2. The method of claim 1, further comprising:
displaying a graphical user interface on the display; and
displaying the virtual gaming controller as an overlay over a portion of the graphical user interface.

3. The method of claim 2, wherein the virtual gaming controller is at least partially transparent to permit the portion of the graphical user interface underlaying the virtual gaming controller to be visible on the display through the virtual gaming controller.

4. The method of claim 1, further comprising detecting a pressure exerted by the user onto the control input of the physical gaming controller, wherein magnitude of the first size of the animated image generated on the display is proportional to a magnitude of the pressure detected on the control input of the physical gaming controller.

5. The method of claim 1, wherein the graphical indicator comprises a first animated image overlaying a first analog control input of the virtual gaming controller and a second animated image overlaying a second analog control input of the virtual gaming controller, and further comprising:
detecting directional movements of the first analog control input of the physical gaming controller and causing the first animated image overlaying the first analog control input of the virtual gaming controller to perform corresponding directional movements and offset on the display from the first analog control input of the virtual gaming controller; and
detecting directional movements of the second analog control input of the physical gaming controller and causing the second animated image overlaying the first analog control input of the virtual gaming controller to perform corresponding directional movements and offset on the display from the second analog input of the virtual gaming controller.

6. The method of claim 1, further comprising, prior to the displaying the virtual gaming controller on the display:
detecting a type of the physical gaming controller being operated by the user; and
displaying, on the display, a type of virtual gaming controller that corresponds to the detected type of the physical gaming controller being operated by the user.

7. A non-transitory computer readable storage medium storing one or more computer programs configured to cause a processor-based system to execute steps comprising:
displaying a virtual gaming controller on a display, wherein the virtual gaming controller is a graphical representation of a physical gaming controller being operated by a user;
detecting, in response to the user interacting with a control input on the physical gaming controller, the control input entered by the user on the physical gaming controller;
generating, on the display, a graphical indicator comprising an animated image and overlaying a control input on the virtual gaming controller that corresponds to the control input entered by the user on the physical gaming controller;
generating the animated image on the display in a first size in response to detecting that the user has engaged the control input of the physical gaming controller; and
generating the animated image on the display in at least one second, smaller, size in response to detecting that the user has released the control input of the physical gaming controller.

8. The non-transitory computer readable storage medium of claim 7, wherein the one or more computer programs is configured to cause the processor-based system to execute further steps comprising:
displaying a graphical user interface on the display; and
displaying the virtual gaming controller as an overlay over a portion of the graphical user interface.

9. The non-transitory computer readable storage medium of claim 8, wherein the virtual gaming controller is at least partially transparent to permit the portion of the graphical user interface underlaying the virtual gaming controller to be visible on the display through the virtual gaming controller.

10. The non-transitory computer readable storage medium of claim 7, wherein the one or more computer programs is configured to cause the processor-based system to execute further steps comprising detecting a pressure exerted by the user onto the control input of the physical gaming controller, wherein magnitude of the first size of the animated image generated on the display is proportional to a magnitude of the pressure detected on the control input of the physical gaming controller.

11. The non-transitory computer readable storage medium of claim 7, wherein the graphical indicator comprises a first animated image overlaying a first analog control input of the virtual gaming controller and a second animated image overlaying a second analog control input of the virtual gaming controller, and wherein the one or more computer programs is configured to cause the processor-based system to execute further steps comprising:
detecting directional movements of the first analog control input of the physical gaming controller and causing the first animated image overlaying the first analog control input of the virtual gaming controller to perform corresponding directional movements and offset on the display from the first analog control input of the virtual gaming controller; and
detecting directional movements of the second analog control input of the physical gaming controller and causing the second animated image overlaying the first analog control input of the virtual gaming controller to perform corresponding directional movements and offset on the display from the second analog input of the virtual gaming controller.

12. The non-transitory computer readable storage medium of claim 7, wherein the one or more computer programs is configured to cause the processor-based system to execute further steps comprising, prior to the displaying the virtual gaming controller on the display:
detecting a type of the physical gaming controller being operated by the user; and
displaying, on the display, a type of virtual gaming controller that corresponds to the detected type of the physical gaming controller being operated by the user.

13. A system, comprising:
a display;
a physical gaming controller; and
a processor-based system in communication with the display and the physical gaming controller and configured to execute steps comprising:
displaying a virtual gaming controller on a display, wherein the virtual gaming controller is a graphical representation of the physical gaming controller;
detecting, in response to a user interacting with a control input on the physical gaming controller, the control input entered by the user on the physical gaming controller;
generating, on the display, a graphical indicator comprising an animated image and overlaying a control input on the virtual gaming controller that corresponds to the control input entered by the user on the physical gaming controller;
generating the animated image on the display in a first size in response to detecting that the user has engaged the control input of the physical gaming controller; and
generating the animated image on the display in at least one second, smaller, size in response to detecting that the user has released the control input of the physical gaming controller.

14. The system of claim 13, wherein the processor-based system is configured to execute further steps comprising:
displaying a graphical user interface on the display; and
displaying the virtual gaming controller as an overlay over a portion of the graphical user interface.

15. The system of claim 14, wherein the virtual gaming controller is at least partially transparent to permit the portion of the graphical user interface underlaying the virtual gaming controller to be visible on the display through the virtual gaming controller.

16. The system of claim 13, wherein the processor-based system is configured to execute further steps comprising detecting a pressure exerted by the user onto the control input of the physical gaming controller, wherein magnitude of the first size of the animated image generated on the display is proportional to a magnitude of the pressure detected on the control input of the physical gaming controller.

17. The system of claim 13, wherein the graphical indicator comprises a first animated image overlaying a first analog control input of the virtual gaming controller and a second animated image overlaying a second analog control input of the virtual gaming controller, and wherein the processor-based system is configured to execute further steps comprising:
detecting directional movements of the first analog control input of the physical gaming controller and causing the first animated image overlaying the first analog control input of the virtual gaming controller to perform corresponding directional movements and offset on the display from the first analog control input of the virtual gaming controller; and
detecting directional movements of the second analog control input of the physical gaming controller and causing the second animated image overlaying the first analog control input of the virtual gaming controller to perform corresponding directional movements and offset on the display from the second analog input of the virtual gaming controller.

18. The system of claim 13, wherein the processor-based system is configured to execute further steps comprising:
detecting a type of the physical gaming controller being operated by the user; and
displaying, on the display, a type of virtual gaming controller that corresponds to the detected type of the physical gaming controller being operated by the user.

19. A method comprising:
processing video data that, when played, displays a virtual gaming controller along with one or more animated images corresponding to one or more control inputs on the virtual gaming controller, wherein as the video data is played, each of the animated images provides a visual indication of manipulations of its respective control input;
based on the visual indication provided by each of the one or more animated images, generating a sequence of the manipulations of the one or more control inputs; and
using the sequence in a processor-based system to generate and display information on a display.

20. The method of claim 19, wherein the using of the sequence in a processor-based system to generate and display information on a display further comprises using the sequence as input to a quality control application.

21. The method of claim 19, wherein the video data, when played, further displays a computer simulation that was controlled by a physical gaming controller that is represented by the virtual gaming controller.

22. The method of claim 19, wherein the generating of the sequence of the manipulations of the one or more control inputs further comprises generating the sequence so that the manipulations of the one or more control inputs in the sequence are substantially synchronized with corresponding manipulations of the one or more control inputs in the video data.
